(19) United States
(12) Patent Application Publication
(10) Pub. No.: US 2021/0139307 A1
(43) Pub. Date: May 13, 2021

(54) Liquid Dairy Product Dispensing Apparatus and System

(71) Applicant: Martin J. Abraham, III, Slidell, LA (US)

(72) Inventor: Martin J. Abraham, III, Slidell, LA (US)

(21) Appl. No.: 17/091,154

(22) Filed: Nov. 6, 2020

Related U.S. Application Data
(60) Provisional application No. 62/932,418, filed on Nov. 7, 2019.

(51) Int. Cl. B67D 1/12; B67D 1/07; B67D 1/10

(52) U.S. Cl. CPC B67D 1/1202; B67D 1/10; B67D 1/07; B67D 1/1281

(57) ABSTRACT

A system for dispensing temperature-controlled milk using only gas pressure, pressure-choke points, and timing controls. Specifically, a system comprising one or more fluid containers stored in a temperature controlled setting, a flow control unit that controls the flow of chilled milk via gas-operated control solenoids, food-grade, air driven pumps, and pinch valves, a temperature-controlled umbilical, and a milk dispensing tower that is in electrical communication with the flow control unit and allows for the measured dispensation of product at a constant temperature, all without the use of any moving valves or other components.

### CROSS-REFERENCE TO RELATED APPLICATIONS

This application claims priority to U.S. Provisional Patent Application No. 62/932,418, filed Nov. 7, 2019, the entirety of which is incorporated by reference as if fully disclosed herein.

### BACKGROUND OF THE INVENTION

### Field of the Invention

The present invention relates generally to a system for dispensing milk or other like liquid dairy products.

### General Background

While dispensation systems for beverages such as soft drinks, tea, juice, and water have long been known, such systems have historically been impractical for dispensing dairy products such as cows' milk. One reason known systems are inadequate for the dispensation of milk or similar dairy products is the need to keep such dairy products at a steady, cold temperature at every step of the storage and dispensation process. Another problem unique to dispensation of dairy products is the need to regularly clean the entirety of the system to prevent the establishment of bacterial or other harmful organisms in the various parts of the dispensation system. Consequently, there exists a need for a dispensation system that provides on-demand milk dispensation in a manner that consumers have come to expect, while at the same time providing both storage-to-dispenser temperature control and easy system cleaning.

### SUMMARY OF THE INVENTION

In accordance with one embodiment, the present invention is an apparatus for dispensing liquid dairy product comprising: (i) a fluid container adapted to hold and maintain liquid dairy product at a desired temperature, (ii) a dispensing unit operable to dispense said liquid dairy product and further comprising a momentary switch, and (iii) a flow control unit comprising at least one pneumatically actuated pump and at least one pneumatically actuated pinch valve, both of which when actuated, allow liquid dairy product to be transported through a tubing from said container, through the pump and pinch valve, and ultimately dispensed from the dispensing unit through a dispenser. For the preferred embodiment, the momentary switch (or dispensing button) on the dispensing unit, when pressed, allows power to at least two solenoid valves within the flow control unit, wherein one solenoid valve is connected to the pneumatic pump and the other is connected to the flow valve. When powered, these solenoid valves open and send pressurized gas to the pump and flow valve, preferably for a set period of time that is governed by a timer; the pressurized gas prompts the pump to stroke while also causing the pinch valve to open, thus allowing the liquid dairy product to flow from the container to the dispenser. When the time delay lapses, the power to the solenoid valves is terminated, thus prompting the pinch valve to close, the pump to stop, and the liquid dairy product to no longer pass through the apparatus. The pinch valve operates to regulate the flow of liquid dairy product by pinching the exterior surface of the tube until the entire flow passage is closed. Use of such a valve prevents unnecessary contamination in the valve caused by the liquid dairy product.

A second embodiment of the invention allows for the added option of cleaning the flow passages within the apparatus by replacing the fluid container holding the liquid dairy product with a fluid container holding a desired cleaning fluid. In this embodiment, the dispensing unit further comprises an additional selector switch in addition to the momentary switch. The selector switch would have two modes, either “dispense” or “clean” mode. When engaged in “dispense” mode, the apparatus would function as described in the first embodiment allowing the liquid dairy product to be dispensed, preferably for a set period of time after pressing the momentary switch. When the selector switch is in “clean” mode, like the first embodiment, the cleaning fluid is pumped through the apparatus and dispensed through the dispensing unit, allowing the tubes transporting the dairy product to be fully irrigated and cleaned. However, unlike the first embodiment, having the selector switch in “clean” mode, the solenoid valves will only be powered when the momentary switch or button is pressed down. Accordingly, the irrigation process will be continuous and ongoing for as long as the momentary switch is activated. The use of the pinch valve is of particular importance; this process allows for the entire system to be thoroughly cleaned without the need of dismantling and cleaning the valve, which is customary for other dispensing systems known in the art.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1. is a system diagram of a milk dispensing system.

FIG. 2 is a perspective view of a fluid container with a quick connect and the associated male connector designed to fit into said quick connect.

FIG. 3 is a side, detailed view of a pinch valve.

FIG. 4 is a top view of a milk dispenser tower showing a plurality of selector switches.

FIG. 5 is a front, perspective view of a milk dispenser tower showing a plurality of momentary switches.

FIG. 6 is a front, perspective view of a flow control unit.

FIG. 7 is a system design for the gas operated solenoid valves in the milk dispensing system.

FIG. 8 is a circuit control design for an embodiment of the invention disclosed herein.

FIG. 9A is a front view of a flow control unit.

FIG. 9B is a bottom view of a flow control unit.

FIG. 9C is a side view of a flow control unit.

FIG. 9D is a front, perspective view of a flow control unit.

FIG. 10 is a front, perspective view of a flow control unit.

FIG. 11 is a series of cutaway views showing a control umbilical.

FIG. 12 is a perspective, cutaway view showing a control umbilical.

FIG. 13 is a front, perspective view of a fluid container connected to a flow control unit.

It should be mentioned that the apparatus described above is scalable and may include a plurality of liquids that may be dispensed. As mentioned above, each added liquid container will require its own pneumatic pump, pinch valve, and corresponding solenoids to transport and regulate the follow of said liquid to a separate dispenser.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures, is not intended to limit the scope of the disclosure, as claimed, but is merely representative of possible embodiments of the disclosure.

FIG. 1 shows an exemplary embodiment of a liquid dairy dispensing system 100. The liquid dairy dispensing system 100 includes one or more fluid containers 110 that are interconnected to a dispensing unit 170 and a flow control unit 150. The flow control unit 150 may be disposed within the housing of the dispensing unit 170. The flow control unit 150 is operable to receive control signals from dispensing unit 170 and to regulate the flow of liquid dairy product from the fluid containers 110 to the dispensing unit 150. One or more umbilical lines 130 (not shown in FIG. 1) connect the flow control unit 150 is connected to the dispensing unit 170.

Exemplary embodiments of the umbilical are shown in FIGS. 11-12. The umbilical 130 is a single line that combines tubes 280 and control wires 290, together with cooling lines 295.

Specifically, umbilical 130 may further comprise a chilled fluid line similar to that employed in U.S. Pat. No. 7,389,647 (which patent is hereby incorporated by reference as if set forth in full herein). Thus, the fluid running through umbilical 130 may be maintained at a constant temperature until it is dispensed via a nozzle 180 (as shown in FIG. 5). FIGS. 12 and 13 show embodiments of umbilical 130.

As shown in FIG. 1, the flow control unit 150 includes a solenoid manifold 205 (as detailed in FIG. 7) connected to pressurized air supply 120 and one or more line regulator assemblies, which include a pump control solenoid valve 210, a pinch valve control solenoid valve 220, a pneumatic pump 230, and an air driven pinch valve 240.

Turning to FIG. 2, an exemplary embodiment of the fluid container 110 and associated male connector 116 is shown. In order to maintain the dairy product at a proper temperature, preferably between 33° F. to 36° F. (but never higher than 40° F.), the fluid container 110 is stored in a cooling device such as a refrigerator. The fluid container 110 may be flexible or rigid and can come in a variety of different shapes and materials. In the embodiment shown in FIG. 2, the fluid container 110 has an outlet that is adapted to attach to one end 115 of a tube 117, where said tube 117 is used to transport the liquid from a container 110 to a pneumatic pump 230 contained within the flow control unit 150 (as shown in in FIG. 13). In an exemplary embodiment, the fluid container 110 is attached to the end 115 of the first tube 117 using a quick-connect male connector 116 and a female connector 112; an example of such a male/female connector pair is a LiquiBox® Fitment #1527 with a flip cap. This type of connection allows for the quick, easy removal and replacement of different containers that may contain different fluids, including different types of dairy products or a cleaning fluid.

Turning again to FIG. 1 and FIG. 6, an exemplary configuration of flow control unit 150 is shown. For each given container 110 connected to flow control unit 150, there is a tube 117 exiting said container 110 which is adapted to attach to a single pneumatically actuated pump 230 at said inlet 231 of said pump 230. In an exemplary embodiment, pneumatic pump 230 is a consumer beverage grade air operated diaphragm pump such as a FLOJET® Model G80 air/gas operated diaphragm pump. These types of air operated diaphragm pumps are ideal as the gas driving the pump never comes into contact with the liquid passing through, thereby avoiding contamination or spoilage. After liquid passes through a pump 230, it exits through outlet 232 into a separate second tube 280 that passes through a pinch valve 240, such as a Clippard® NPP Series 2-Way, normally-closed pneumatic pinch valve, before terminating at dispenser 170. In an exemplary embodiment, tubes 117 and 280 are made of food-grade silicone tubing.

A detailed view of an exemplary pinch valve is shown in FIG. 3. As shown, pinch valves 240 are advantageous because, unlike other valve types that have internal passages that may cause small amounts of fluid or other residue to remain in the valve, pinch valves have no areas or dead volume where fluid can become trapped; only the inside of the tubing has contact with the fluid, and the fluid is completely isolated from the valve itself.

Turning to FIG. 1 and FIG. 7, the flow control unit 150 includes at least two solenoid valves 210 and 220, one to actuate a pneumatic pump 230, and the other to actuate and open a pinch valve 240. In operation, these solenoid valves control the flow of pressurized gas from air supply 120 to pump 230 and valve 240 based on control signals sent from dispensing unit 170 to the solenoid valves 210, 220. These solenoid valves 210, 220 are configured in a normally closed position; examples of such a solenoid valve is a B Series solenoid valve offered by Gems such as Gems solenoid valve part number B3014-4-BB-LB-C103. Electrical power to the solenoid valves is provided by an external power source regulated by a momentary switch 172 (i.e., the dispensing button) that is preferably located on the exterior surface of the dispensing unit 170 (as shown in FIG. 5). When the momentary switch 172 is pressed, the circuit to the solenoid valves 210 and 220 is closed, sending the required electrical current to open the solenoid valves 210 and 220 and allow the pressurized gas to flow to both the pneumatic pump 230 and the pinch valve 240. The pinch valve 240 remains closed in its natural state; the pressurized gas will cause the valve 240 to open and remain open so long as pressure is maintained. A diagram showing a configuration of said solenoids valves, as connected to the air supply 120, is shown in FIG. 7.

Turning to FIGS. 4-5, the dispensing unit 170 further comprises a plurality of selector switches 171, which gives the user the option to clean the flow passages (i.e. the first tube 117, pneumatic pump 230, umbilical lines 130, and dispenser nozzle 180) of the apparatus in addition to allowing the dispensing functions described above for the liquid dairy product. In an exemplary embodiment, each selector switch 171 is a Wes Garde 2Gm04-78 and has three modes, namely “clean”, “dispense” and “off.” When the switch is in “dispense,” the apparatus functions as described below in the first preferred embodiment for dispensing the dairy product. In order to avoid excess flow of the dairy product through the pinch valve 240 and ultimately out of the dispenser 170, the circuit between the solenoid valves 210 and 220 and the momentary switch 172 may be equipped with a time delay relay 175 that allows the circuit to remain closed for a fixed period of time. For example, the time delay relay 175 shown in FIG. 5 is a Schneider Electric TDRSOXP-24 which allows for a time delay that can last up to ten seconds. The purpose of incorporating this feature is that when a user activates the momentary switch 172, the circuit will be closed for a set interval of time, thus causing the pinch valve to remain open for the time interval before being closed again; this process precludes the user from accidently overserving his glass, resulting in unnecessary waste, a mess, or spillage. At a minimum, the dispensing unit 170 must allow the dispenser 180 to be accessible as well as allow access to the momentary switch 172 used to actuate the flow of fluid from each individual fluid container 110.

FIG. 8 illustrates an exemplary control circuit associated with a single faucet of dispenser unit 170. Transformer 510 takes as an input normal line voltage (120V AC) and converts same to 24 V AC, where in an exemplary embodiment, transformer 510 is a 40 VA transformer. In-line fuse 512 protects the system, where in an exemplary embodiment fuse 512 is rated for 3 amps. When selector switch 171 (FIG. 4) is set to dispensing mode and momentary switch 172 (FIG. 5) is depressed, relay coil 545 is energized, which closes contact 520, which in turn energizes time delay relay coil 175. Timed relay coil 175 then remains closed for a preset amount of time (selected to optimally limit the amount of liquid dispensed each time momentary switch 172 is depressed), thus closing contact 525, which in turn supplies power to solenoids 210 and 220, which operate pump 230 and valve 240 (not shown), respectively. When timed relay 175 opens, power is cut to solenoids 210 and 220, thus stopping pump 230 and closing valve 240. Where selector switch 171 is set to cleaning mode and momentary switch 172 is depressed, relay coil 540 is energized and contact 530 is closed, thus providing power to solenoids 210 and 220; however, as soon as momentary switch 172 is released, coil 540 is de-energized, and power is cut to solenoids 210 and 220.

When the selector switch 171 is in “clean” mode, the circuit providing power to the solenoids 210 and 220 bypasses the time delay relay 175, thus requiring the user to hold the momentary switch 172 down to continuously provide power to the solenoids 210 and 220, which in turn, provides the pressurized gas needed to open the pinch valve 240 and stroke the pump 230 to allow the cleaning fluid to flow through the apparatus. As soon as the user releases the momentary switch 172 in this mode, the circuit will be re-opened and power no longer provided to the solenoids 210 and 220. As a result, while holding the momentary switch 172 down, cleaning fluid is continuously irrigated through the flow passages until a desired cleaning result is obtained. In similar fashion, a fluid container of water can be connected to the apparatus and the process repeated to flush out any residue left behind by the cleaning solution.

FIGS. 9A-D and FIG. 10 show additional views of an embodiment of flow control unit 150.

An alternative embodiment of the invention allows the apparatus to include a cleaning function. For this embodiment, the fluid container 110 holding the liquid dairy product is replaced by a separate container 110 containing a cleaning fluid such as Purdy Products Stera-Sheen® Green Label. It is anticipated that each fluid container has the quick-connect connector 112 described above that allows for easy substitution of these separate fluid containers 110.

In one embodiment, the liquid dairy dispensing system 100 may include four 3 way toggle switches, such as Wes-Garde 2GM04-7; four momentary switches, such as Parts Express #060-636 (P-31-02-614), Parts Express #060-630 (P-31-02-509), or Parts Express #060-644 (P-32-03-312); one 40 VA Transformer-Acme Ref. JAR 4031F (JARD); one 3.0 Amp. Fuse-Parts Express-071-702; one 4.0 Amp. Fuse-Parts Express-071-704; one in-line AGC Fuse Holder-Parts Express-070-609; four 24 v. Interval Timer Relay & Bases-I.D.-TDRSOXPX-24, 70-464-1; eight 24 v. Ice Cube Relays & Base-Industrial Electronics-782XBXM4L-24A; one 2 screw Romex connector-Nulite-BP650DC2; one 15 amp cord & plug (P5-15Nema) Electric cord sets-13723; 18 ga. wire selection such as black 500′ rolls, white 500′ rolls, yellow 500′ rolls, red 500′ rolls, green 500′ rolls, blue 500′ rolls, or orange 500′ rolls; 18 ga. 4 Conductor Wire-Shielded Plenum Cable-G80-291 JS; seven B321 Grommets-Hillman-H405772; ten Heat Shrink-Fastnal-(1/22″-0710603) (¼″-0710599); twenty Eyelets-60037; forty 3/16″ Insulated Sta-on Female Connectors-Fastnal0705158; thirty-two ¼″ Insulated Sta-on Female con. Fastnal-0710367; thirty-two ¼″ Insulated Sta-on Male Con. Fastnal-0711102; and four 5 port Wago connectors PEI-221-415.

In one embodiment, the flow control unit 150 may include four Dairy Pumps-Flojet-H80E0000; four Wall Brackets-Barb Style Chudnow; one 0-100 Secondary Style Regulator-Tap Rite; four Pinch Valve-Clipper; four MettleAir Fittings-¼″ ODx 10-32UNF-(MTL1/4-U1010) Amazon; eight (SS bolt-4-40×⅜″) Fastnal-1172482; four 24v Solenoid Valves B3014-4-BB-LB-C103; four Bar Manifolds; two ¼″ Hex coupling; two ¼″ MPT Plugs; two ¼″ MPT×⅜″ Barb; four ¼″ MPT×⅜″ Barb; four ¼″ MPT×⅜″ JG. Push-In; four ⅜″ Stem×¼″ JG. Push-In; eight_/4″ FPT×⅜″ Push-In Coupling JG; six ⅜″ JG. Tees; two ⅜″ JG. Elbows; and 60″ silicone tubing (Versilon SPX-50)( 7/16″ OD× 1/16″ wall) ABX00022 (Norton Performance Plastic Corp.) 1-800-209-6260.

What is claimed is:

1. An apparatus for dispensing liquid dairy product comprising:
a. a fluid container adapted to hold liquid dairy product;
b. a dispensing unit operable to dispense said liquid dairy product through a dispenser;
c. a flow control unit comprising at least one pinch valve and one pump;
wherein said flow control unit is operable to regulate the flow of said liquid dairy product from said fluid container to said dispenser.

2. The apparatus of claim 1 comprising a first tube and a second tube,
wherein said first tube connects said fluid container to said pump,
wherein said second tube connects said pneumatic pump to said dispenser,
wherein said pump is operable to transport said liquid from said first tube through said second tube and said dispenser,
wherein said pinch valve is operable to regulate the flow of the liquid through said second tube.

3. The apparatus of claim 2 wherein the fluid container connected to the first tube using a quick-connect connector.

4. The apparatus of claim 2 wherein the pump and pinch valve are pneumatic.

5. The apparatus of claim 2 comprising a time delay relay operable to actuate the pump and open the pinch valve for a set time interval.

6. The apparatus of claim 5 wherein said time delay relay ranges from 0-10 seconds.

7. The apparatus of claim 2 comprising at least one additional fluid container adapted to hold a liquid product, at least one separate dispenser within said dispensing unit, and wherein said fluid control unit comprises at least one separate pump and at least one separate pinch valve within said fluid control unit, wherein each said additional fluid container is connected to said separate dispenser within said dispensing unit through one or more tubes in series, and wherein each said separate pump and said separate pinch valve within said flow control unit are operable to transport and regulate the flow of said liquid through the apparatus to each said separate dispenser.

8. An apparatus for dispensing liquid dairy product and cleaning fluid comprising:
a. a first fluid container adapted to hold a liquid dairy product;
b. a second fluid container adapted to hold cleaning fluid;
c. a first tube and a second tube;
d. a dispensing unit comprising a selector switch operable to dispense either said liquid dairy product or said cleaning fluid through a dispenser;
e. a flow control unit further comprising at least one pump and at least one pinch valve,
wherein said first tube connects either of said first fluid container or said second fluid container to said pump,
wherein said second tube connects said pneumatic pump to said dispenser,
wherein said pump is operable to transport said liquid from said first tube through said second tube and said dispenser,
wherein said pinch valve is operable to regulate the flow of the liquid through said second tube.

9. The apparatus of claim 8 wherein said first and second fluid containers are connected to said first tube using a quick-connect connector.

10. The apparatus of claim 8 wherein the pump and pinch valve are pneumatic.

11. The apparatus of claim 8 further comprising a time delay relay operable to actuate the pump and open the pinch valve for a set time interval when the selector switch is operable to dispense liquid dairy product.

12. The apparatus of claim 11 wherein said time delay relay ranges from 0-10 seconds.

13. A method for dispensing liquid dairy product, said method comprising the steps of:
a. providing an apparatus comprising:
i. a fluid container adapted to hold liquid dairy product;
ii. a dispensing unit operable to dispense said liquid dairy product through a dispenser;
iii. a flow control unit comprising at least one pinch valve and one pump;
wherein said flow control unit is operable to regulate the flow of said liquid dairy product from said fluid container to said dispenser.
b. providing power generation capabilities to said pump;
c. providing power generation capabilities to open said pinch valve;
d. pumping said liquid dairy product from said fluid container, through said pinch valve to said dispenser;

14. The method of claim 13 further comprising the step of adding a time delay relay operable to limit said power generation capabilities to said pump and said pinch valve for a set time interval.

15. The method of claim 14 further providing the step of actuating the time delay relay to regulate the amount of said liquid dairy product that flows from said fluid container to said dispenser.

16. The method of claim 13 further comprising the step of replacing said fluid container with a substitute cleaning fluid container.

17. The method of claim 16 further comprising the step of using quick-connect release means for replacing said fluid container with said cleaning fluid container.
